(19) United States
(12) Patent Application Publication
(10) Pub. No.: US 2014/0042009 A1
(43) Pub. Date: Feb. 13, 2014

(54) MULITI-EFFECT DISTILLATION DEVICE

(71) Applicants: Bin-Juine Huang, Taipei (TW); Shih-Lin Chang, Taipei (TW)

(72) Inventors: Bin-Juine Huang, Taipei (TW); Shih-Lin Chang, Taipei (TW)

(73) Assignee: Bin-Juine Huang

(21) Appl. No.: 13/572,689

(22) Filed: Aug. 12, 2012

(51) Int. Cl. B01D 3/02

(52) U.S. Cl. 202/174

(57) ABSTRACT

Present invention is a practical, highly efficient, structurally simple, low production cost, easy to manufacturing, and inexpensive multi-effect distillation device composed of thin-laminated distiller which is tangled into spiral and becomes layers of centric circle; one side of surface of said distiller is condensing surface which is for condensation of vapor of water, condensed distilled water is drained from underneath of said condensing surface, another side of said distiller is attached with a piece of wick which is made of capillary materials, undistilled water enters from above of the wick, than be absorbed and distributed by said wick. Some of the water absorbed on said wick is evaporated into the vapor of water. There is a gap between condensing surface and wick of each adjacent layers. The top and bottom of said gap is sealed to prevent leaking of the vapor of water.

### BACKGROUND OF THE INVENTION

1. Field of Invention

The present invention relates to an apparatus for distilling water and, more particularly, to a spiral multi-effect distillation device.

2. Related Prior Art

A diffusive type multi-effect distillation device is a highly effective, heat-driven distillation system. Dunkle [M. Telkes, Solar still construction, US Department of the Interior, Office of Saline Water Research and Development, Progress Report No. 33, 1959.] was the first to mention the theory of multiple-effect diffusion still (MEDS) in 1959. Referring to FIG. 1, the conventional diffusive multi-effect distillation device consisted of multiple distillers (C) extending parallel to one another. Distillers (C) are in laminate form, one side was used as a condensing surface (C1), where vapor would condense and the distilled water (DW) would drop down and be collected underneath said condensing surface C1. The other side would be attached to a capillary material as a wick (C2). The undistilled water (W) would enter from the top of said wick C2 and be absorbed by the wick, than some of the water absorbed on wick is evaporated into the vapor by heat, and unevaporated water become the drained waste water XW which is drained from underneath of wick. The arrangement of the distillers were to make the condensing surface C1 face to the wick C2 of another distiller C, put in parallel, align sides each other, and there is a small gap between said condensing surface C1 and wick C2. In operation, the heat (P) from outward heat sources such as the heating device A, solar energy or thermal energy from the vapor heats up the condensation surface C1 of the marginal distiller C. Then the thermal energy is transferred onto the wick and the water W absorbed by the wick C2 is evaporated into vapor HW. Afterward, the vapor HW, travels to the condensing surface of the second distiller C through convection and diffusion, and condenses into distilled water DW. When the wick and condensing surface is close enough, natural convection is suppressed, and the vapor mostly moves to another surface through diffusion.

At the same time, the latent heat released during above-mentioned process of condensation becomes the heat source of the next distiller C, and when the heat is conducted to the second distiller's wick, water W absorbed on the wick will evaporated into vapor HW. This process repeats until the last distiller, than the heat is drained from the device. Because the multi-effect design enables repeating use of the single input heat, it increases the efficiency of distillation. Compared to a single-effect device, the multi-effect design can produce more distilled water with the same amount of input heat. In addition, because the diffusion mass transfer efficiency increases when the gap between two distillers decreases, the size of the distiller can be reduced when narrowing the distance of this gap.

Due to the diffusive-type distillation device's compact and unique structure, the design and manufacture is extremely difficult. For example, within every narrow still cell (composed of the wick, gap, and condensing surface), the inflow and outflow of water, air tightness, and strength of structure all need to be considered.

One of the most complex issues during the manufacture process is to maintain the small distance between the wick of one distiller and the condensing surface of the next distiller. If there is contact between the two surfaces, the distilled water might be contaminated by the undistilled water or vice versa. In order to enable the appropriate distance between two distillers, the structure of the distiller must be rigid and strong enough. Generally, distillers are made by materials that are hard, or thick with high thermal conductivity.

Another issue is the air tightness of the sides of the distillers. The sealing of the sides has to be strong and precise enough. Sometimes, even a pressing mechanism is required.

In addition, in order to conduct heat thoroughly, the wick C2 has to be tightly attached to the distiller. If there is any slight detachment, the efficiency of the device will decrease. The common method is to press the sides, but this will increase weight and complexion of the device. Another method is to use adhesive to fix the wick. However, this increases the difficulty of future changing of materials, and also increases heat resistance. Some adhesive also contain substance that might contaminate the water. The wick, allowing in-flowing water to flow thoroughly to stay wet uniformly, and the air tightness and strength of the structure, which makes the design and production become more difficult.

The most common application of distillation device such as desalting seawater, due to mess impurities inside the seawater, to prevent crystal of mess impurities in the seawater attaches on said capillary material which reduces the effect of the device, new undistilled seawater need to be added in and drain out the concentrated waste water continuously, but much heat still contained by the drained waste water, and the distilled water which is produced by the distillation device is also with mess of heat left; Therefore, if heat recycle can occur, this heat can be used to pre-heat the undistilled water before it is distilled and also the media in which the heat source uses to transfer the heat, increasing the system's efficiency. The temperature of each distillers' drained waste water and distilled water is different (decreasing from closest to the heat source), therefore the ideal way to recycle the heat would be to separate these different temperatures of water and then utilize them. However, this is too complicated and the common method is to mix the waters together and then recycle the heat. This method obviously does not utilize the heat to the maximum.

Due to the above reasons, conventional distillation device has always been too complex in design and manufacture, and therefore less practical. This present invention provides a new structure that can solve many of the above problems. Instead of using many distillers, the new structure only requires one piece of distiller, and the effect is still retained. In addition, the wick and distiller can be easily attached together and the structure of the distiller doesn't have to be rigid. Its unique structure enables uniform of in-flowing water and solves the air tightness issues, lowering difficulty of production. Also designed is a heat recycle device that can highly increase the exchange temperature, therefore enhancing the effect. Most importantly, this present invention has highly enhanced the efficiency of the diffusive type distillation device, for same amount of heat input and distilled water production, the area of distillation is much smaller than conventional devices, and the capacity of the device is also decreased.

### SUMMARY OF THE INVENTION

It is the primary objective of the present invention to provide a practical, highly efficient, structurally simple, low production cost and easy manufacturing multi-effect distillation device.

To achieve the foregoing objective, present invention is composed of at least one thin laminated distiller 1,

Characterized by:
Said distiller 1 is constructed in a spiral structure which is tangled from a central circle with vertical axis to outer; the inner surface of the tangled distiller is condensing surface 11 which is for condensation of vapor of water HW, condensed distilled water DW is drained from underneath of said condensing surface 11. the outer surface of the tangled distiller is attached with a piece of wick 12 which is made of capillary materials, undistilled water W enters from above of the wick 12, than be absorbed and distributed by said wick 12; some of the water absorbed on said wick 12 is evaporated into the vapor of water HW, and unevaporated water in said wick 12 become the drained waste water XW which is drained from underneath of said wick 12; there is a gap 13 between condensing surface 11 and wick 12 of each adjacent layers;
The top and bottom of said gap 13 is sealed to prevent leaking of the vapor of water HW;
The inner surface of the most interior layer of the tangled distiller is heating surface, and the outer surface of the most exterior layer of the tangled distiller is heat radiating surface;

When said heating surface is heated, the heat from heat source is conducted to the wick 12 which is at the back of the heating surface, and evaporate the water of said wick 12 into vapor of water HW, the vapor of water HW diffuse through the close space S which is formed by sealed gap 13, most of vapor of water HW is condensed on the condensing surface 11 next to the corresponding wick 12; The latent heat of the vapor of water HW is released when the vapor of water HW condenses into water, and heat the water of the wick 12 of next layer, the process is going until the heat is conducted to said heat radiating surface and radiated to the air.

Furthermore, said distiller includes at least one distilled water heat recycling pipe 111 below the condensation face surface 11. The fluid in pipes have good thermal contact with the distilled water DW running down from condensation face, and through heat exchange, the distilled water DW (higher temperature) can heat up the fluid in pipe (lower temperature), to recycle the excess heat of distilled water.

Said distiller includes at least one drained waste water heat recycling pipe 121 below the wick 12. The fluid in pipes have good thermal contact with the drained waste water XW running down from wick, and through heat exchange, the drained waste water XW (higher temperature) can heat up the fluid in pipe (lower temperature), recycling the heat of drained waste water XW.

A water collecting channel 14 is disposed on the bottom of each condensing surface 11 for collecting the distilled water DW which drops from the condensing surface 11.

There is a vapor transporting tube 3 inside the space S which is in the central circle and is formed by said heating surface for inputting vapor into said space S.

Said heating surface which is inside the central circle of the tangled distiller 1, surrounds a heating device 2.

Said heating device 2 includes a water container 23.

Said heating device 2 is with a cylinder heat supplying surface 21, the outside of said heat supplying surface 21 is also attached with a piece of cylinder wick 22 which is made of capillary material, and said cylinder wick 22 is absorbing and saturated with water;

Said heat supplying surface 21 is capable of transforming outer energy in different forms into thermal energy, and the heat is conducted to said cylinder wick 22 by said heat supplying surface 21, to evaporate the water in the cylinder wick 22. The vapor of water HW diffuses to and condenses on the heating surface.

At least one water distributor 4 which is made of capillary material and connected with the wick 12 is disposed on the top of said wick 12. Undistilled water W first enters into said water distributor 4, and be distributed evenly to the wick 12 through capillarity.

There are separating sticks 5 which is disposed in right angel with said distiller 1, to divide said gap 13 into multiple chambers.

Said distiller 1 is tangled in one of below-listed 3 types:

The height of central circle is the highest, and the layer which is farther from the central circle, the height of the layer is lower.

The height of central circle and else layers of circles are the same.

The height of central circle is the lowest, and the layer which is farther from the central circle, the height of the layer is higher.

### BRIEF DESCRIPTION OF DRAWINGS

FIG. 1 is the scheme of the operation principle of conventional multi-effect diffusion distillation device.

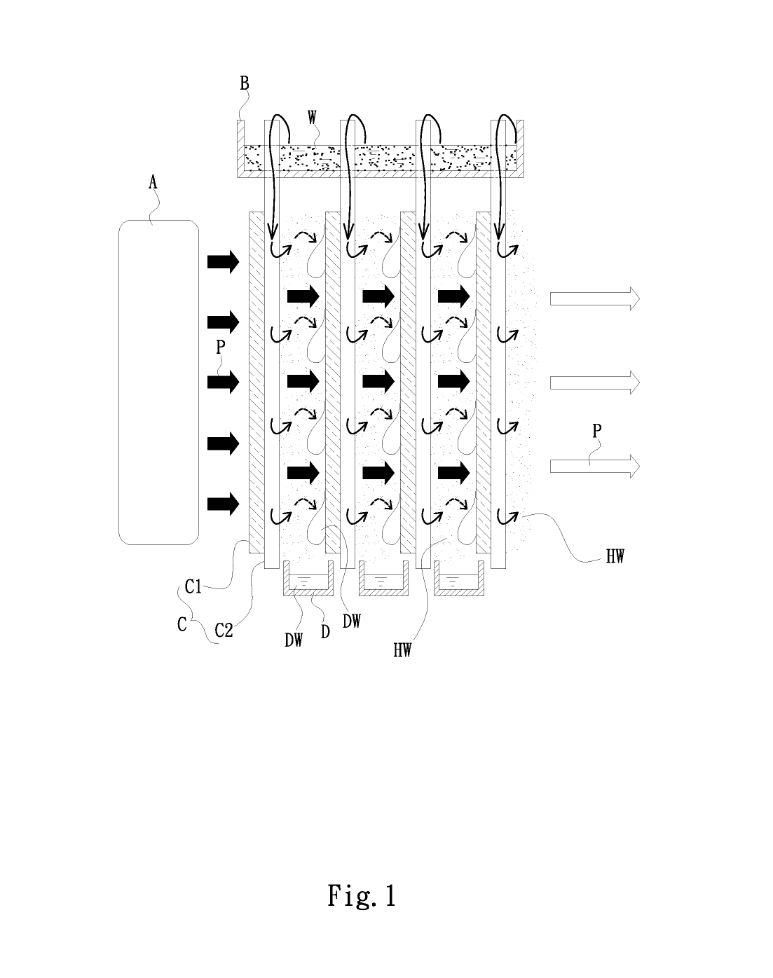

FIG. 2 is 3D view of present invention

FIG. 3 is the cross section of I-I embodiment of present invention.

FIG. 4 is the cross section of II-II embodiment of present invention.

FIG. 5 is the cross section of I-I embodiment of present invention in practice.

FIG. 6 is the cross section of II-II embodiment of present invention in practice.

FIG. 7. is the cross section of I-I embodiment of present invention in practice with 2nd type of distiller.

FIG. 8. is the cross section of I-I embodiment of present invention in practice with vapor transporting tube.

FIG. 9 is the cross section of I-I embodiment of present invention in practice with 3rd type of distiller.

FIG. 10 is the cross section of II-II embodiment of present invention in practice with separating sticks.

FIG. 11 is the cross section of II-II embodiment of present invention in practice with another type of heating device.

### DETAIL DESCRIPTION OF THE INVENTION

Detail description of present invention with corresponding drawings is as following:

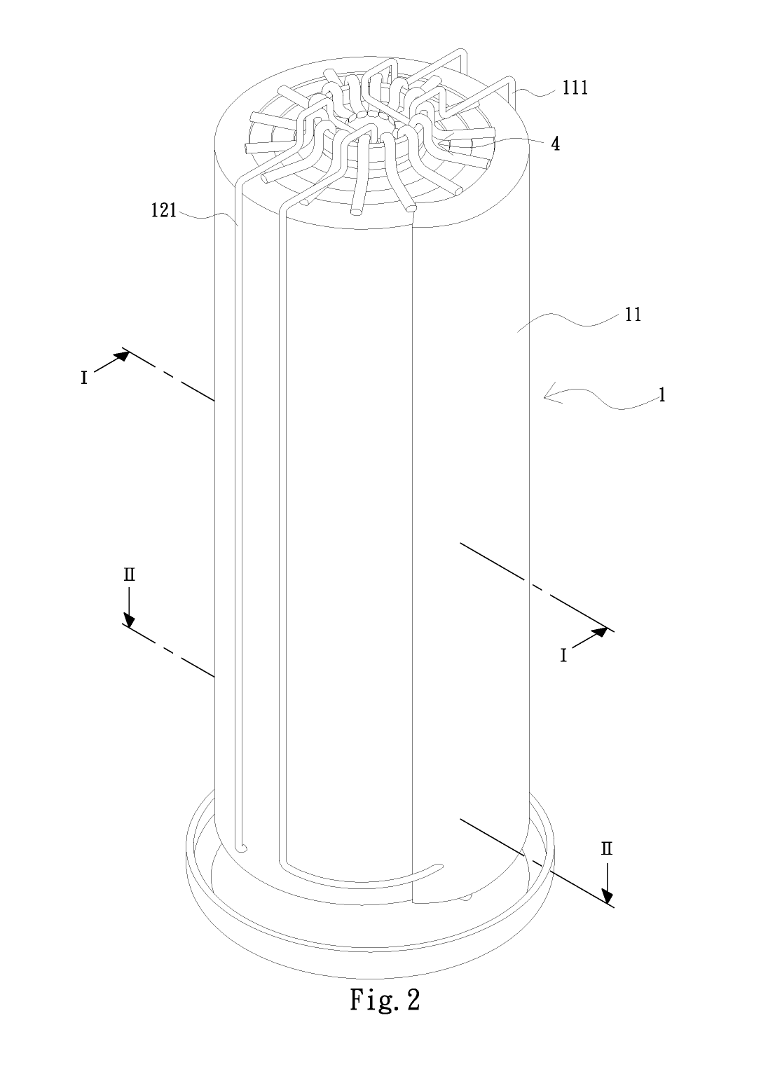

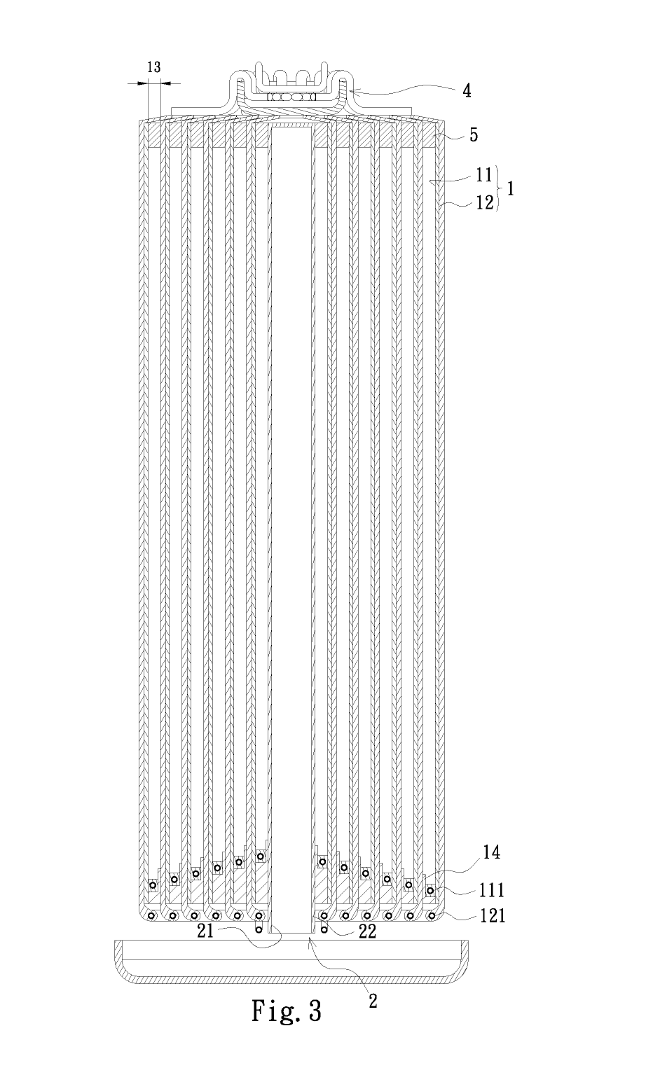

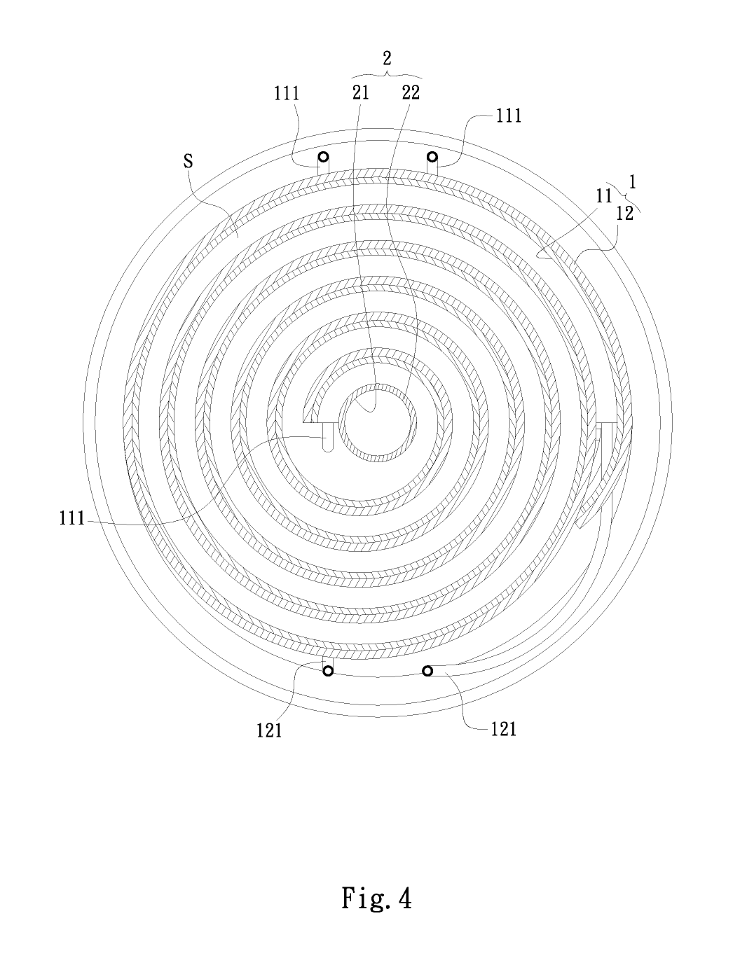

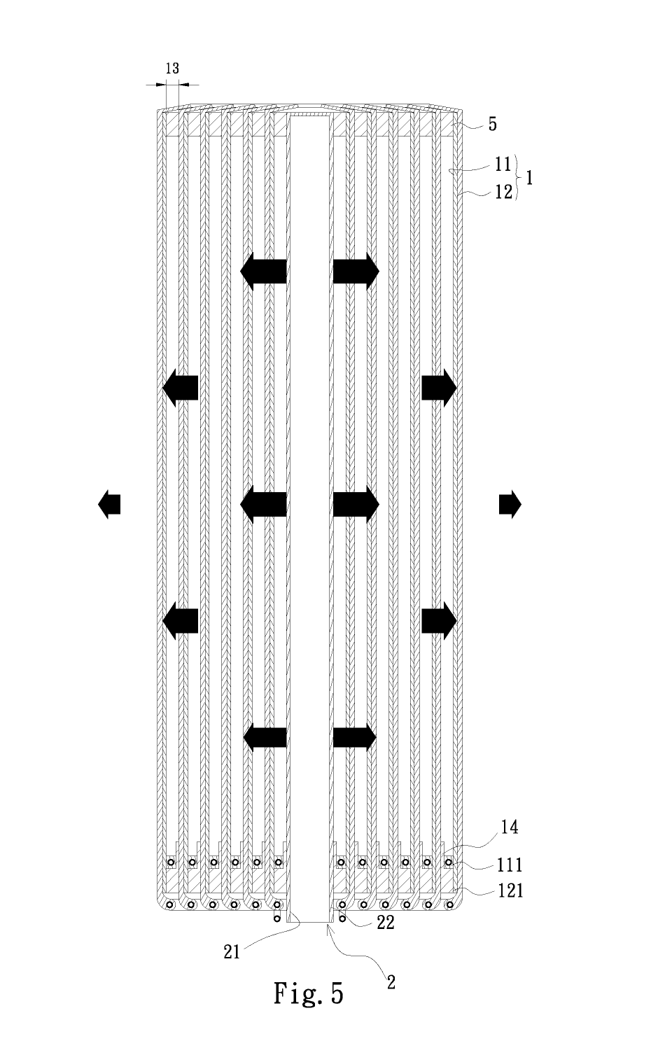

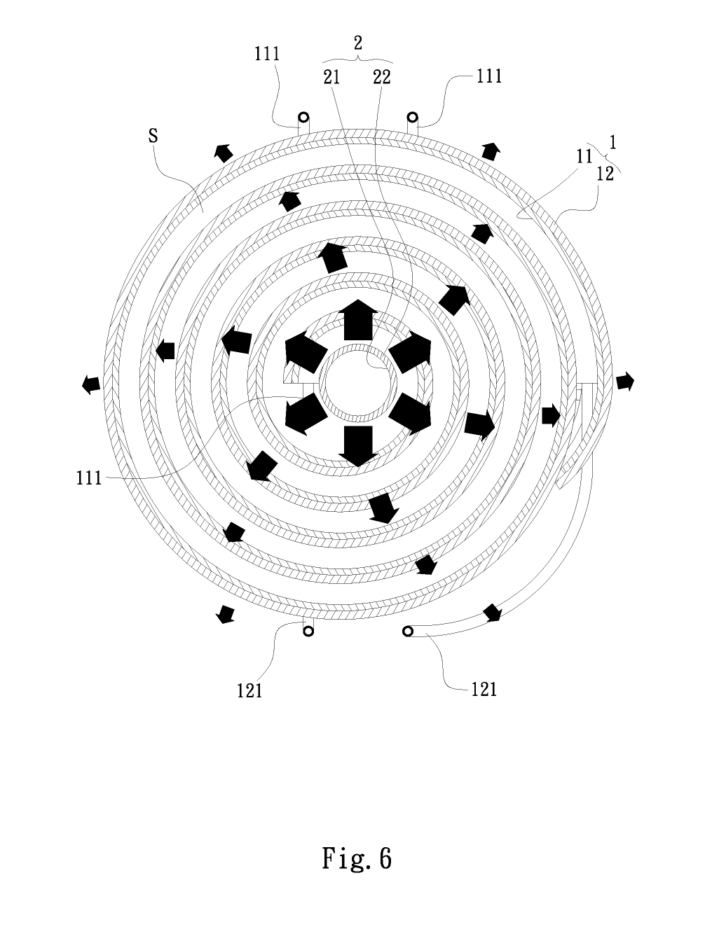

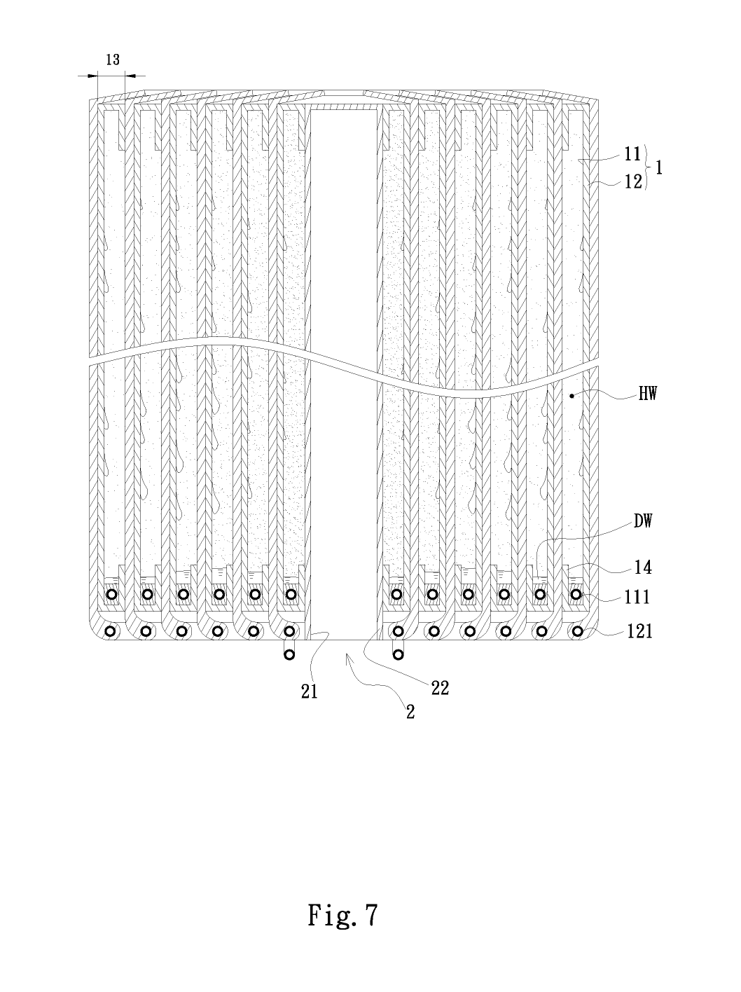

Refer FIGS. 2-7, which reveal present invention is composed of:

At least one thin laminated distiller 1,

Characterized by:

Said distiller 1 is constructed in a spiral structure which is tangled from a central circle with vertical axis to outer; the inner surface of the tangled distiller is condensing surface 11 which is for condensation of vapor of water HW, condensed distilled water DW is drained from underneath of said condensing surface 11. the outer surface of the tangled distiller is attached with a piece of wick 12 which is made of capillary materials, undistilled water W enters from above of the wick 12, than be absorbed and distributed by said wick 12; some of the water absorbed on said wick 12 is evaporated into the vapor of water HW, and unevaporated water in said wick 12 become the drained waste water XW which is drained from underneath of said wick 12; there is a gap 13 between condensing surface 11 and wick 12 of each adjacent layers;

The top and bottom of said gap 13 is sealed to prevent leaking of the vapor of water HW;

The inner surface of the most interior layer of the tangled distiller is heating surface, and the outer surface of the most exterior layer of the tangled distiller is heat radiating surface;

When said heating surface is heated, the heat from heat source is conducted to the wick 12 which is at the back of the heating surface, and evaporate the water of said wick 12 into vapor of water HW, the vapor of water HW diffuse through the close space S which is formed by sealed gap 13, most of vapor of water HW is condensed on the condensing surface 11 next to the corresponding wick 12; The latent heat of the vapor of water HW is released when the vapor of water HW condenses into water, and heat the water of the wick 12 of next layer, the process is going until the heat is conducted to said heat radiating surface and radiated to the air.

Through the application of distiller of present invention with specific structure, the following advantages are as below:

1. Using Only One Distiller for Multi-Effect Distillation:
Within the device, the vapor evaporated from the wick 12 will diffuse through the gap 13 in both radial and tangential direction to nearby condensing surfaces. Most vapor of water HW condenses on the nearest condensing surface in radial direction; while only small portion condenses tangentially to surfaces of further distance. When the ratio of the wick's radius and the gap distance is larger, the proportion of vapor condensed onto the nearest condensing surface is larger too. The latent heat released during condensation then transfers to the wick on the back of the condensing surface and evaporate the water on it. Condensation then occurs on the next nearest surface and the process is repeated until excess heat is released from the device. Because heat is transferred almost completely in radial direction, this present invention enables the use of one distiller, shaped spirally to form a single and connected gap, which can execute multi-effect distillation. This innovation saves a lot of manufacturing trouble compared to the conventional device, because the separation of every individual gap is no longer needed.

2. Resolving Structure Issues:
The spiral tangled distiller 1 in this invention is fixed with airtight strips above and below, and remains its curved structure throughout. Its surface structure is stronger than flat, straight distillers of the same flexible material. In other words, the surfaces can maintain smooth without distortion more easily. Therefore, a thin but flexible material can easily meet the strength requirements. The laminated distiller enables reduction of weight and increases the heat conductivity. Therefore, even materials with lower heat conductivity can also be used, which increases the flexibility to choose the material of lower cost.

3. Resolving Air Tightness Issues:
With conventional flat distillers, all four sides need to be airtight to ensure heat is contained within the distillers and the multi gaps. On the other hand, the single spiral distiller in this present invention only has one gap that is a circularly connected inside out. Therefore, only the top and bottom sides need to be airtight. If strips of flexible material are used, then the strips and distiller sheet can be winded together; with enough tension, the strips can naturally attach to the distiller, forming an airtight gap. Therefore, the difficulties regarding air tightness encountered while manufacturing conventional distillers can be easily resolved in this present invention.

4. Resolving Wick Attachment Issues:
In this present invention, the spiral tangled distiller 1 is an arch structure throughout the device. The wick 12 which attach on the convex side of the distiller 1 with tension, will attach tightly spontaneously. The manufacturing process will be considerably easier than conventional devices, just winding the wick and distiller sheet together with proper tension. No pressing or adhesive material is used in this attachment, and therefore is more convenient for replacement in the future.

5. Uniformity of In-Flowing Water:
In this present invention, the wick 12 is a connected, individual material throughout the entire device. In addition, each spiral layer's wick 12 makes contact at the top. Therefore, in-flowing water can easily penetrate sideways and downwards through the capillary material, moisturizing the wick uniformly. Compared to the conventional diffusion-type distillation device, where each distiller's wick is separate, this invention enables more uniformity of in-flowing water.

6. Increase of Production Efficiency (Larger Production to Distiller Area Ratio):
In an ideal condition without any heat loss (100% heat recycle and heat insulation), a diffusion-type distillation device releases all the input heat at the most outer layer of distiller 1. This means that at every layer of the distiller 1, whether a single spiral piece or multiple flat pieces, the amount of heat transferred is identical. Therefore, the layer of distiller with the largest heat resistance determines the amount of heat transferred throughout the entire device.
The heat resistance for each layer is dominated by the vapor's diffusion rate, and is inversely proportional to the distiller's area and temperature. In this present invention, because the radius of layers increase from inside to outside, the distillation area increases. However, the temperature decreases in the same direction. Therefore, each layer has similar heat resistance and all of the distillation area is effectively utilized. For conventional devices, however, distillation area is usually identical throughout, and the most outer layer has largest heat resistance and determines the amount of heat transferred. This means the inner layers are less effectively utilized because heat resistance is small but not that much heat is transferred due to outer layer's larger resistance. Compared to the conventional device, this invention can produce same amount of distilled water from same amount of heat but with less distillation area required.

7. Decrease of Device Size:
In conventional devices, other than the most outer (cooling) surface, heat insulation is required throughout the entire device. However, in this invention, only the top and bottom need insulation and loss of heat will be minimized, which saves a lot of space needed than before for thermal insulation. In addition, due to the spiral structure, there already exists a room for the heating device 2 in the center circle of the spiral structure. Also, the heat recycling setup can be winded with the distiller 1 at the bottom. Finally, almost all of the volume in this invention is utilized for distillation, reducing a lot of rooms needed for else applications than prior art.

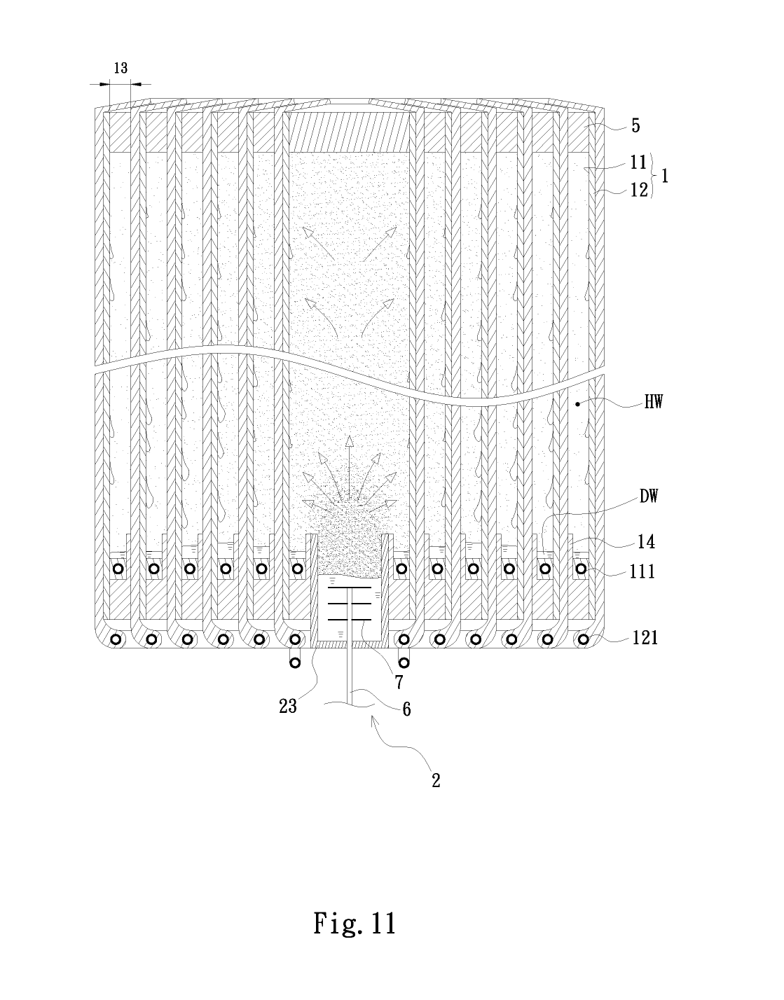

8. Complementing Overflow of Heat:
In this invention, because the gap 13 between spiral tangled distiller is a through space from inside out; when there is excess heat input causing heat overloading, vapor with higher pressure can still travel and condense on the outer layers, and the device is still functional properly. However, in conventional devices with isolated layers of distillers, the overpressure vapor of water might leak out from the distillers causing loss of thermal energy, and overheat may lead to damage of the device.
Said distiller 1 includes at least one distilled water heat recycling pipe 111 below the condensing surface 11. The fluid in pipes have good thermal contact with the distilled water DW running down from the condensing surface 11, and through heat exchange, the distilled water DW (higher temperature) can heat up the fluid in pipe (lower temperature),to recycle the excess heat of distilled water DW.
Furthermore, said distiller 1 includes at least one drained waste water heat recycling pipe 121 below the wick 12. The fluid in pipes have good thermal contact with the drained waste water XW, and through heat exchange, the drained waste water XW (higher temperature) can heat up the fluid in pipe (lower temperature), recycling the heat of drained waste water XW.
The designation of distilled water heat recycling pipe 111 and drained waste water heat recycling pipe 121 of present invention is for recycling the left heat contained in distilled water DW and drained waste water XW in distillation process through heat exchange, and the recycled heat can be applied for preheating the undistilled water or the heat source to increase operating effect of present invention.
Secondary, the pipes for flowing of the liquid being preheated can be spiral tangled and disposed under the spiral tangled distiller 1. The condensed water from condensing surface 11 and the waste water from the wick 12 can have heat exchanging with the fluid in the pipes to heat the fluid; Because the temperature of waste water XW and distilled water DW from different parts of said distiller 1 are different, which the position is closer to the heat source, the temperature of drained distilled water DW and waste water XW are higher; there is a spiral draining channel under said distiller 1, which depend on the difference of height to make the distilled water DW or waste water XW flows out from the position with higher temperature to the position with lower temperature. To make the flow direction of the fluid inside the pipe be opposite to the flowing direction of distilled or waste water, than the fluid inside the pipe can be heated by the fluid outside the pipe with higher and higher temperature gradually to become quite hot. For the case of conventional distillation device, the temperature of liquid after preheated will be much lower, since the heat exchanging occurs after drained water of different temperatures being mixed.
Otherwise, single distiller structure of present invention can unite the heat recycling pipe and distiller 1 completely, and only occupied small volume, to compare with prior art, the out-plug heat recycling device is no longer needed in present invention. In the other hand, the left heat contained by distilled water and waste water have always been recycled before draining out, which can reduce more loss of thermal energy than prior art, which makes the heat recycling device of present invention becoming simpler and more effective.
A water collecting channel 14 is disposed on the bottom of each condensing surface 11 for collecting the distilled water DW which drops from the condensing surface 11.
With the application of said water collecting channel 14, the distilled water DW can be collected effectively, and with the usage of said distilled water heat recycling pipe 111, the heat contained by distilled water DW is going to be recycled before draining out to reduce the loss of thermal energy.
The heating surface which in the most interior layer of spiral tangled distiller 1 surrounds to a heating device 2; and said heating device 2 comprises a water container 23.
Said heating device 2 is with a heat supplying surface 21, the surface of said heat supplying surface 21 is attached with a cylinder wick 22 which is made of capillary material. Said cylinder wick 22 is absorbing and saturated with water;
Said heat supplying surface 21 is capable of transforming outer energy in different forms into thermal energy, and the heat is transferred to said cylinder wick 22 by said heat supplying surface 21, to evaporate the water in the cylinder wick 22. The vapor of water HW diffuses to and condenses on the heating surface of spiral tangled distiller 1, as shown in FIG. 11, through the application of said water container, there would be some different heating apparatus such as the combination of electrical heating rod 6, and heat conducting fins 7 can be applied.
With the structure of distiller in present invention, said heating device 2 can be disposed in the originally existing space which is in the center of said distiller 1.The space can be sufficiently used which the extra volume of the device don't have to increase for disposing the heating device 2.
Secondary, because the heating device 2 is surrounded by said distiller 1, the thermal energy from said heating device 2 can be transferred to the surrounding heating surface directly which is the most interior inner surface of spiral tangled distiller 1, to reduce the chances of losing thermal energy, so the thermal energy is used more effectively.
Thirdly, the form of input energy of said heating device 2 is subject to vapor energetic, solar, electricity . . . etc, which is more convenient to be applied.
Fourthly, Due to the settlement of water container and cylinder wick 22, thermal energy can be transferred by evaporating water, diffusing and condensing of the vapor of water, which takes effect of first distillation, and in the meanwhile, without directly contact with the heating device 2 can avoids damage of the distiller 1 caused by burning, which extends the operation period of said distiller 1.

At least one water distributor 4 which is made of capillary material and connected with the wick 12 is disposed on the top of said wick 12. Undistilled water W first enters into said water distributor 4, and be distributed evenly to the wick 12 through capillarity.

Said water distributor 4 can distribute water to said wick 12 more evenly, and filter the mess impurities in said undistilled water W which is not dissolvable in water before the water be absorbed by said wick 12, so the operation period of said wick 12 can be much extended. Since the said water distributor 4 is disposed separately from the distiller 1, it can be replaced easily without disassembling the distiller 1.

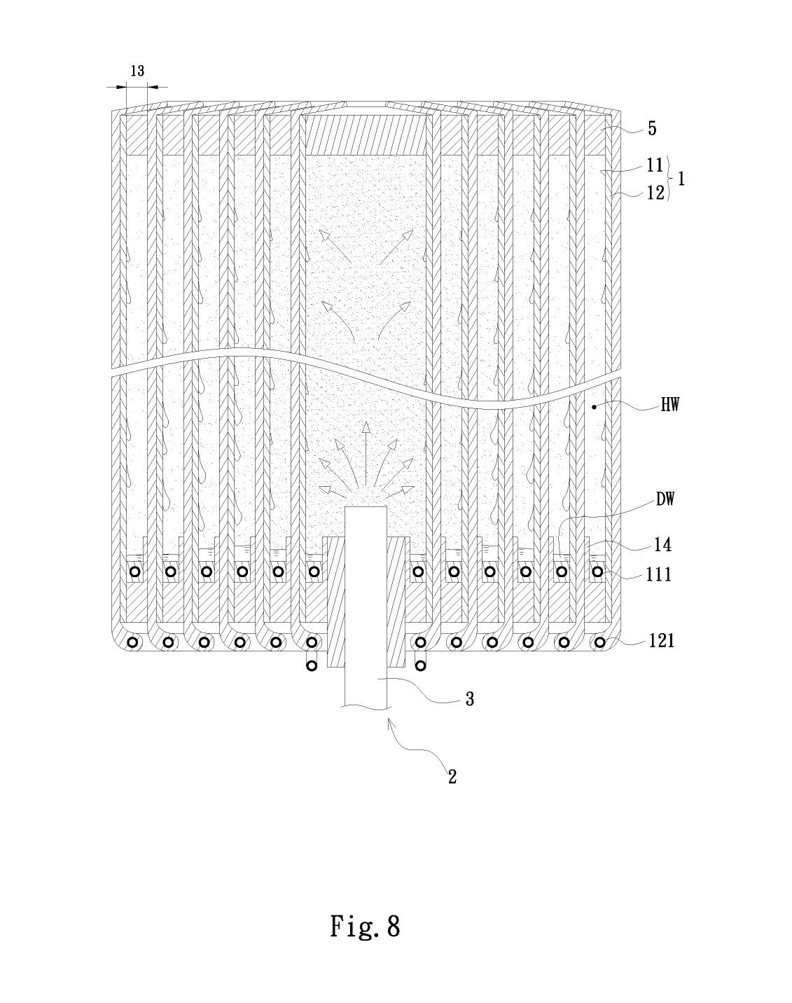

Refer FIG. 8 which reveals there is a vapor transporting tube 3 inside the space S which is in the central circle and is formed by said heating surface which is the most interior inner surface for inputting vapor into said space S.

Outcome vapor is input from said vapor transporting tube 3, condensed on the condensing surface 11 of the distiller 1 and release the latent heat to become the heat source of present invention, condensed water from outcome vapor becomes a part of production of present invention, and heating device is no longer needed, so the cost of manufacturing is reduced, and the heat and water of outcome vapor are totally used without wastes.

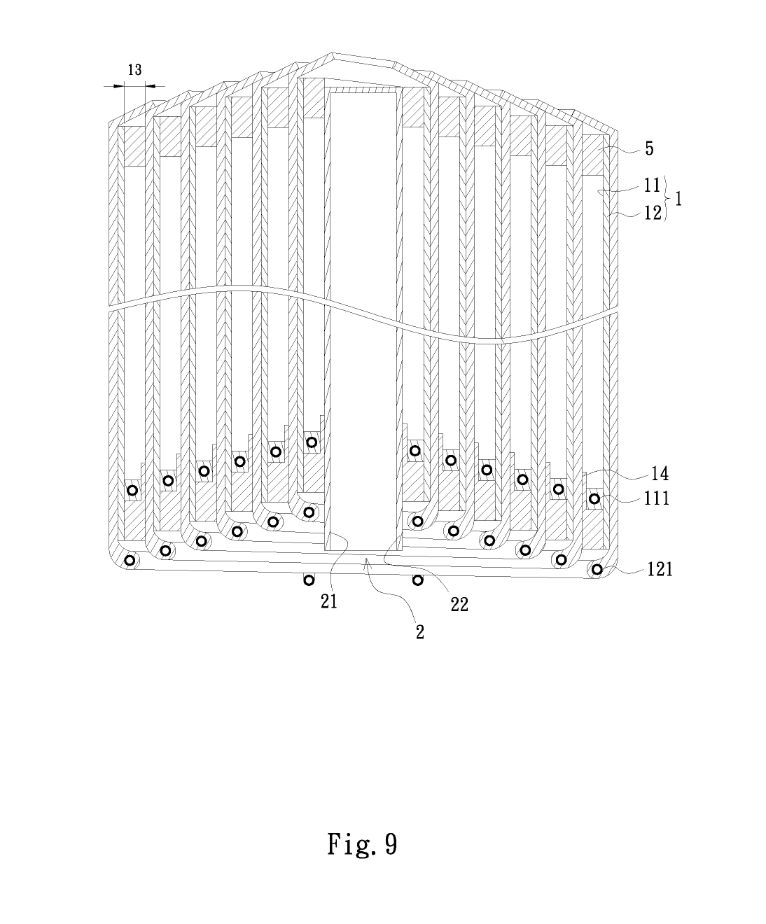

Refer FIG. 9 which reveals Said distiller 1 is tangled in one of below-listed 3 types:

The height of central circle is the highest, and the layer which is farther from the central circle, the height of the layer is lower;

The height of central circle and else layers of circles are the same;

The height of central circle is the lowest, and the layer which is farther from the central circle, the height of the layer is higher.

Different ways of settling said distiller 1 can be varied by designations of appearance and the way of draining distilled water and waste water to make present invention meets the need of different manufactures.

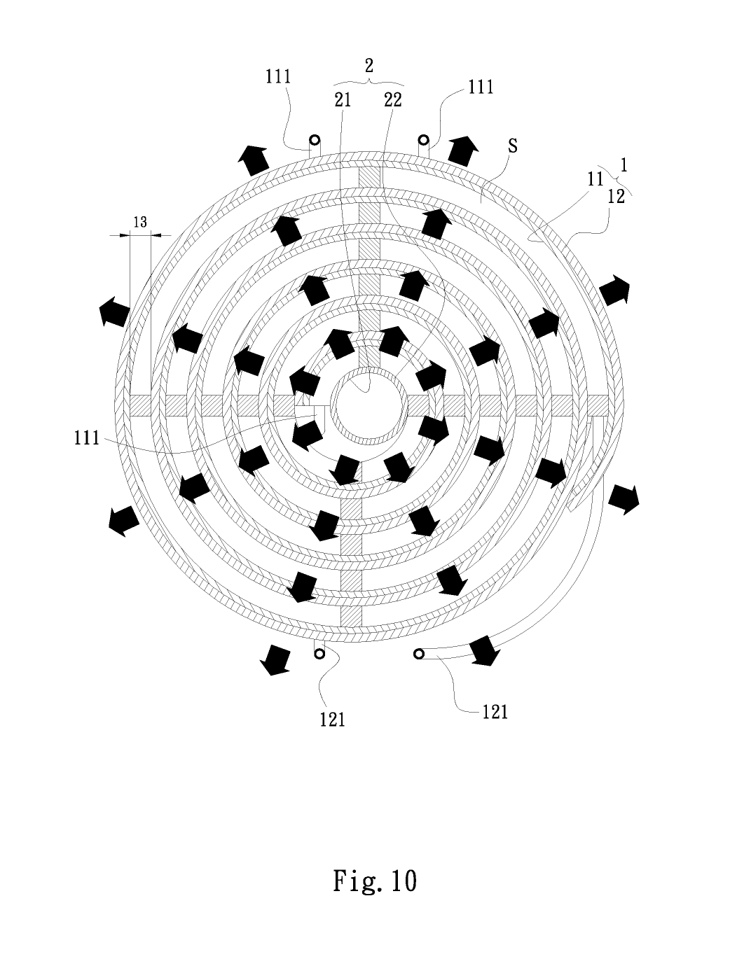

Refer FIG. 10 which reveals Said distiller includes at least one separating stick, that is parallel to the central distiller's axis of tangled distiller 1, and disposed inside the distiller 1 and becomes vertical with the distiller 1. The separating sticks can separate each gap 13 forming into multiple chambers to make the radiating path of thermal energy close to straight to promote the effect of heat transformation.

According to the above-described embodiments, the advantages of present invention are concluded as below:
1. Achieving multi-effect with single distiller.
2. The difficulty of manufacture of the distiller is much less, and the choice of manufacture material is more flexible, these can largely decrease the weight and cost of the device.
3. Solve the problem about attachment between said wick 12 and distiller 1, and distributing water evenly.
4. The heat recycling device of present invention can promote the effect of heat recycling.
5. Upgrading the effect of diffusion distillation device, the total needed area of distiller of present invention is much smaller than prior art.
6. The use of space is economic, since almost whole volume of present invention are applied for distillation, else parts like heat supplying, heat recycling and heat isolating devices only occupy few space.

The present invention is described, but not limited in the drawings and related description of the embodiments, said methods of practice and refer embodiments are only cases with best effect. Modifications and creations based on the scope and skill of present invention sought to be deemed to be infringements of the claims of present invention.

1. A multi-effect distillation device is composed of:
At least one thin laminated distiller 1,
Characterized by:
Said distiller 1 is constructed in a spiral structure which is tangled from a central circle with vertical axis to outer; the inner surface of the tangled distiller is condensing surface 11 which is for condensation of vapor of water HW, condensed distilled water DW is drained from underneath of said condensing surface 11. the outer surface of the tangled distiller is attached with a piece of wick 12 which is made of capillary materials, undistilled water W enters from above of the wick 12, than be absorbed and distributed by said wick 12; some of the water absorbed on said wick 12 is evaporated into the vapor of water HW, and unevaporated water in said wick 12 become the drained waste water XW which is drained from underneath of said wick 12; there is a gap 13 between condensing surface 11 and wick 12 of each adjacent layers;
The top and bottom of said gap 13 is sealed to prevent leaking of the vapor of water HW;
The inner surface of the most interior layer of the tangled distiller is heating surface, and the outer surface of the most exterior layer of the tangled distiller is heat radiating surface;
When said heating surface is heated, the heat from heat source is conducted to the wick 12 which is at the back of the heating surface, and evaporate the water of said wick 12 into vapor of water HW, the vapor of water HW diffuse through the close space S which is formed by sealed gap 13, most of vapor of water HW is condensed on the condensing surface 11 next to the corresponding wick 12; The latent heat of the vapor of water HW is released when the vapor of water HW condenses into distilled water DW, and heat the water of the wick 12 of next layer, the process is going until the heat is conducted to said heat radiating surface and radiated to the air.

2. The multi-effect distillation device according to claim 1 wherein said distiller includes at least one distilled water heat recycling pipe 111 below the condensation surface 11. The fluid in pipes have good thermal contact with the distilled water running down from condensing surface, and through heat exchange, the distilled water (higher temperature) can heat up the fluid in pipe (lower temperature) to recycle the heat of distilled water.

3. The multi-effect distillation device according to claim 1, wherein said distiller includes at least one drained waste water heat recycling pipe 121 below the wick 12. The fluid in pipes have good thermal contact with the drained waste water XW running down from wick, and through heat exchange, the drained waste water XW (higher temperature) can heat up the fluid in pipe (lower temperature), recycling the heat of drained waste water XW.

4. The multi-effect distillation device according to claim 1, wherein a water collecting channel 14 is disposed on the bottom of each condensing surface 11 for collecting the distilled water DW which drops from the condensing surface 11.

5. The multi-effect distillation device according to claim 1, wherein said space S which is formed by said heating surface, comprises a vapor transporting tube 3 for inputting vapor into said space S.

6. The multi-effect distillation device according to claim 1, wherein said heating surface which is the most interior inner surface of the distiller 1, surrounds a heating device 2 which is characterized by:
Said heating device 2 includes a water container 23;
Said heating device 2 is capable of transforming outer energy in different forms into thermal energy than heat and evaporate the water in the water container to produce the vapor of water HW which transfers and condenses on the heating surface of distiller 1;

7. The multi-effect distillation device according to claim 1, wherein said heating surface which is the most interior inner surface of the distiller 1, surrounds a heating device 2 which is characterized by:
Said heating device 2 includes a heat supplying surface 21;
Said heat supplying surface 21 is attached with a cylinder wick 22 which is made of capillary material; Said cylinder wick 22 is absorbing and saturated with water;
Said heating device 2 can convert any form of energy that is input into heating device 2 into thermal energy, and then transfer the heat to said heat supplying surface 21, heating and evaporating the water on the cylinder wick 22, the vapor transfers and condenses on the heating surface of said distiller 1.

8. The multi-effect distillation device according to claim 1, wherein said wick is connected to at least one distributor 4 which is made of capillary material and disposed on the top of said wick for distributing the undistilled water to said wick evenly through capillarity.

9. The multi-effect distillation device according to claim 1, wherein said distiller includes at least one separating stick, which is parallel to the central axis of tangled distiller 1, and inside the distiller 1, for separating each gap 13 into multiple chambers (S).

10. The multi-effect distillation device according to claim 1, wherein said distiller 1 is tangled in one of below-listed 3 types:
The height of central circle is the highest, and the layer which is farther from the central circle, the height of the layer is lower.
The height of central circle and else layers of circles are the same.
The height of central circle is the lowest, and the layer which is farther from the central circle, the height of the layer is higher.
